(19) United States
(12) Patent Application Publication
(10) Pub. No.: US 2011/0075887 A1
(43) Pub. Date: Mar. 31, 2011

(54) Lens shift measuring apparatus, lens shift measuring method, and optical module manufacturing method

(75) Inventor: Yoshiharu Tanaka, Kanagawa (JP)

(73) Assignee: RENESAS ELECTRONICS CORPORATION, Kawasaki-shi (JP)

(21) Appl. No.: 12/923,533

(22) Filed: Sep. 27, 2010

(30) Foreign Application Priority Data
Sep. 29, 2009 (JP) 2009-224989

(51) Int. Cl. G06K 9/00; B32B 37/02

(52) U.S. Cl. 382/106; 156/64

(57) ABSTRACT

The lens shift measuring apparatus calculates a position of a predetermined portion of a frame body, on the basis of an imaging result obtained by imaging reflected light from the frame body, in a state in which light is irradiated onto a lens-attached member having a lens and the frame body to hold the lens, such that the reflected light from the frame body is generated, and calculates a position of a focusing spot, on the basis of an imaging result obtained by imaging light transmitted through the lens, in a state in which the light is irradiated onto the lens-attached member, such that the focusing spot formed by focusing the light transmitted through the lens by the lens is generated, and calculates a shift amount of the position of the focusing spot with respect to the predetermined portion as the shift of the lens.

### BACKGROUND

This application is based on Japanese patent application No. 2009-224989, the content of which is incorporated hereinto by reference.

### TECHNICAL FIELD

The present invention relates to a lens shift measuring apparatus, a lens shift measuring method, and an optical module manufacturing method.

### RELATED ART

For example, in a CAN package of an optical semiconductor element that is used for optical communication, it is general to perform packaging using a cap (hereinafter, referred to as lens cap) where a lens is hermetic sealed to a central portion, in order to obtain optical coupling with an optical fiber or optical coupling with a receptacle to connect the optical fiber. The lens cap is hermetic sealed by resistance welding with respect to a disk-like block (stem) where a chip, such as a laser diode, is mounted.

When the lens cap is hermetic sealed, the stem and the lens cap are positioned on the basis of the external positions thereof and are welded to each other. In this case, if the lens is eccentric to the cap, since the position of the lens with respect to a light emission point of the laser diode that is mounted on the center of the stem is shifted, the position of a focusing spot of the laser diode where light is focused by the lens may also be shifted from the center of the CAN package.

As such, if the position of the focusing spot of the laser diode is shifted from the center of the CAN package, in the following processes, when the CAN package is bonded to the optical fiber or the receptacle to constitute an optical module (optical semiconductor device), time is needed to adjust an optical axis or optical coupling efficiency of the optical module is lowered.

For this reason, when the optical semiconductor element for the optical module is assembled, before the CAN package is sealed, it is needed to previously measure a lens eccentric amount of the lens cap and exclude the lens cap having an eccentric amount out of the standard, or to perform position correction according to the measured eccentric amount when the CAN package is sealed. Accordingly, a technology for measuring the lens eccentricity of the lens cap becomes important.

In Japanese Laid-open patent publication No. 2005-221471, a lens eccentricity measuring apparatus that measures an eccentric amount of a lens is described. This lens eccentricity measuring apparatus has a lens eccentricity measuring jig that holds the lens, when the eccentricity of the lens is measured. The lens eccentricity measuring jig includes a mounting table on which a lens-attached member where the lens is held in a frame body is mounted, a holding member that contacts an outer edge of the frame body of the lens-attached member provided on the mounting table and positions the lens-attached member, and a rotating mechanism that rotates the lens-attached member.

Measurement by the lens eccentricity measuring apparatus that is disclosed in Japanese Laid-open patent publication No. 2005-221471 is performed as follows. First, the lens-attached member is mounted on the mounting table, measurement light is irradiated onto the lens of the lens-attached member through a pinhole while the lens-attached member is rotated by the rotating mechanism, and plural image data is obtained by imaging returned light from a surface of the lens. Next, an eccentric amount of the lens with respect to the frame body of the lens-attached member is calculated by executing image processing on the image data. Specifically, if the trace of the position of a virtual image of a point light source from which light is irradiated onto the lens through the pinhole is detected by executing image processing on the plural image data and the position of the virtual image does not change, it is determined that the lens is not eccentric. Meanwhile, if the position of the virtual image changes and forms the circular trace, it is determined that the lens is eccentric and a radius of the trace is calculated as the eccentric amount of the lens with respect to the frame body.

### SUMMARY

However, the present inventor has recognized as follows. According to the technology that is disclosed in Japanese Laid-open patent publication No. 2005-221471, the following problems occur.

First, since the eccentric amount of the lens is measured by rotating the lens-attached member, the rotating mechanism that rotates the lens-attached member is needed, the apparatus configuration is complicated, and a manufacturing cost increases.

The plural image data is acquired in the course of rotating the lens-attached member and the eccentric amount is calculated on the basis of the processing result of the image data. For this reason, a measurement time may be needed.

Since the measurement light is irradiated onto the surface of the lens and the position of the reflected light (returned light) is detected, the shift of the optical axis of the lens that occurs when the lens is mounted to be inclined to the frame body cannot be measured. For this reason, the position shift of the focusing spot of the laser diode by the lens when the optical module is assembled cannot be accurately estimated.

As such, it is difficult to calculate the position shift amount of the focusing spot of the lens due to the eccentricity of the lens with respect to the frame body and calculate the position shift amount of the focusing spot of the lens due to the inclination of the lens with respect to the frame body in short time, using an apparatus having the simple configuration.

In one embodiment, there is provided a lens shift measuring apparatus, including: an irradiating unit which irradiates light onto a lens-attached member having a lens and a frame body to hold the lens, such that a reflected light from the frame body and a focusing spot formed by focusing light transmitted through the lens by the lens is generated; an imaging unit which includes the lens-attached member in an imaging range; and an image processing unit that executes image processing on an imaging result obtained by the imaging unit and calculates a shift of the lens, wherein the imaging unit images the reflected light from the frame body and the light transmitted through the lens, and the image processing unit executes, as the image processing, a first process, in which, a position of a predetermined portion of the frame body is calculated on the basis of an imaging result of the reflected light, a second process, in which, a position of the focusing spot is calculated on the basis of an imaging result of the light transmitted through the lens, and a third process, in which, a shift amount of the position of the focusing spot with respect to the predetermined portion is calculated on the basis of processing results of the first and second processes, as the shift of the lens.

According to the lens shift measuring apparatus, the position of the predetermined portion of the frame body may be calculated on the basis of the imaging result of the reflected light from the frame body of the lens-attached member, the position of the focusing spot by the lens may be calculated on the basis of the imaging result of the light transmitted through the lens, and the shift amount of the position of the focusing spot with respect to the predetermined portion of the frame body may be calculated on the basis of the calculated positions. Accordingly, the shift amount of the position of the focusing spot due to the shift of the lens (eccentricity or inclination of the lens with respect to the frame body) may be calculated without rotating the lens-attached member. That is, a rotating mechanism that rotates the lens-attached member is unnecessary, and the shift amount of the position of the focusing spot due to the eccentricity or the inclination of the lens with respect to the frame body may be calculated as the shift of the lens, using an apparatus having the simple configuration.

Further, imaging does not need to be performed over plural times in the course of rotating the lens-attached member, and only one-time imaging maybe performed in a state in which the position of the lens-attached member is fixed. Alternatively, one-time imaging may be performed with respect to each of the reflected light from the frame body and the light transmitted through the lens, in a state in which the position of the lens-attached member is fixed. For this reason, the shift amount of the position of the focusing spot may be measured in short time.

Since the position of the focusing spot of the light focused by the lens is calculated on the basis of the imaging result of the light transmitted through the lens, the position shift of the focusing spot due to the inclination of the lens may be calculated.

That is, the position shift amount of the focusing spot of the lens due to the eccentricity of the lens with respect to the frame body and the position shift amount of the focusing spot of the lens due to the inclination of the lens with respect to the frame body may be calculated in short time using an apparatus having the simple configuration.

In another embodiment, there is provided a lens shift measuring method including: calculating a position of a predetermined portion of a frame body, on the basis of an imaging result obtained by imaging reflected light from the frame body, in a state in which light is irradiated onto a lens-attached member having a lens and the frame body to hold the lens, such that the reflected light from the frame body is generated; calculating a position of a focusing spot, on the basis of an imaging result obtained by imaging light transmitted through the lens, in a state in which the light is irradiated onto the lens-attached member, such that the focusing spot formed by focusing the light transmitted through the lens by the lens is generated; and calculating a shift amount of the position of the focusing spot with respect to the predetermined portion as a shift of the lens.

In another embodiment, there is provided an optical module manufacturing method including: calculating a position of a predetermined portion of a frame body, on the basis of an imaging result obtained by imaging reflected light from the frame body, in a state in which light is irradiated onto a lens-attached member having a lens and the frame body to hold the lens, such that the reflected light from the frame body is generated; calculating a position of a focusing spot, on the basis of an imaging result obtained by imaging light transmitted through the lens, in a state in which the light is irradiated onto the lens-attached member, such that the focusing spot formed by focusing the light transmitted through the lens by the lens is generated;

calculating a shift amount and a shift direction of a position of the focusing spot with respect to the predetermined portion as a shift of the lens; and bonding a stem of a stem unit, which has the stem, a carrier provided on the stem, and a light emitting element provided on the carrier, to the frame body of the lens-attached member. In the bonding of the stem of the stem unit to the frame body, a relatively positions of the stem unit and the lens-attached member are corrected such that the shift amount calculated by the calculating of the shift amount and the shift direction of the position of the focusing spot is corrected, and the stem and the frame body are bonded to each other.

According to the invention, the position shift amount of the focusing spot of the lens due to the eccentricity of the lens with respect to the frame body and the position shift amount of the focusing spot of the lens due to the inclination of the lens with respect to the frame body may be calculated in short time using a lens shift measuring apparatus having the simple configuration.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a schematic front cross-sectional view of a lens shift measuring apparatus according to a first embodiment;

FIG. 2 is a diagram showing an image of a lens cap (lens-attached member) that is obtained by imaging epi-illumination light;

FIG. 3 is a diagram showing an image of a lens cap (lens-attached member) that is obtained by imaging transmissive illumination light;

FIGS. 4A and 4B are schematic front cross-sectional views of a lens cap (lens-attached member) showing the position shift of a focusing spot by the lens shift. FIG. 4A shows the case where the lens is eccentric, and FIG. 4B shows the case where the lens is inclined;

FIG. 5 is a flowchart showing a flow of the operation of a lens shift measuring method according to the first embodiment;

FIG. 6 is a diagram showing image processing for calculating the central position of the lens cap (lens-attached member), which shows a state in which three or more windows are disposed in an image;

FIG. 7 is a diagram showing an example of a change curved line of brightness of an image in a radial direction in the window of FIG. 6;

FIG. 8 is a diagram showing a curved line that is obtained by performing primary differentiation on the change curved line of FIG. 7;

FIG. 9 is a schematic cross-sectional view showing an example of an optical module that is manufactured by an optical module manufacturing method according to the first embodiment;

FIG. 10 is a schematic front cross-sectional view of a lens shift measuring apparatus according to a second embodiment;

FIG. 11 is a flowchart showing a flow of the operation of a lens shift measuring method according to the second embodiment; and

FIG. 12 is a schematic front cross-sectional view of a lens shift measuring apparatus according to a first modification.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Embodiments of the present invention will be explained below, referring to the attached drawings. Note that any similar constituents will be given the same reference numerals or symbols in all drawings, and explanations therefor will not be repeated.

### First Embodiment

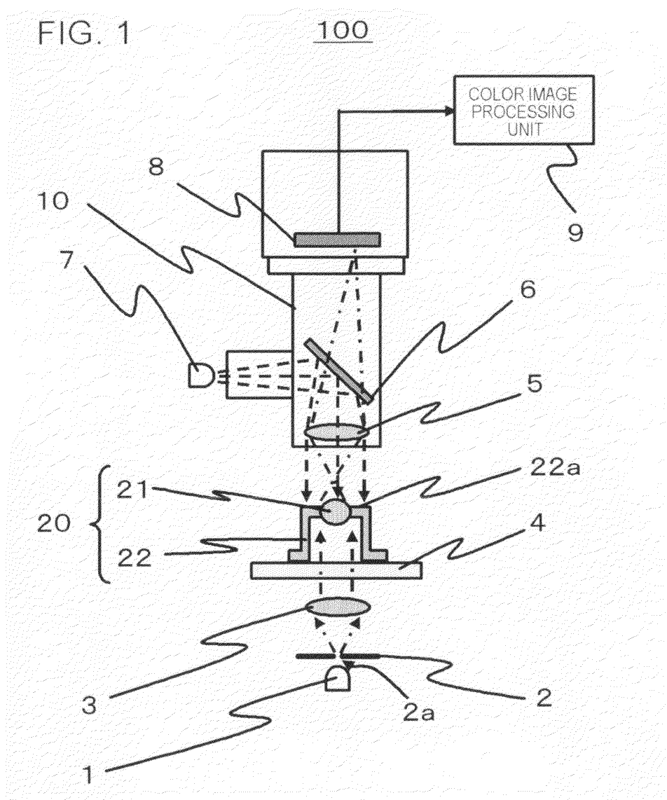

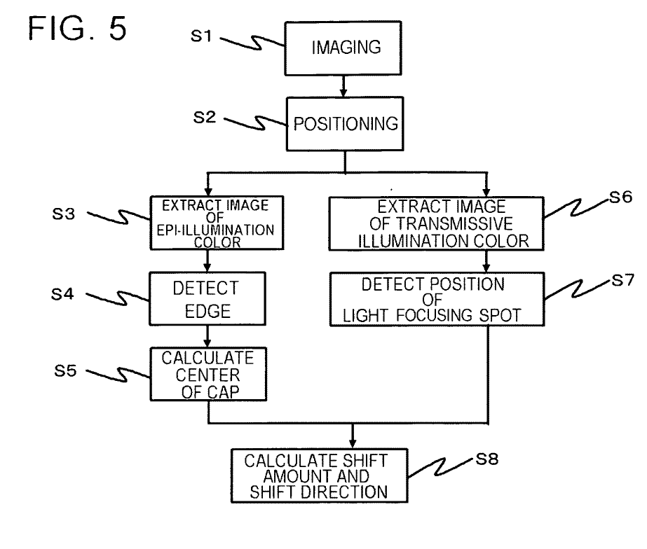

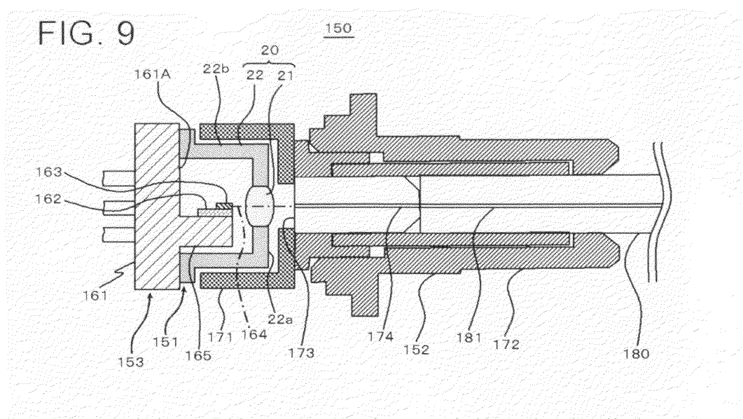

FIG. 1 is a schematic front cross-sectional view of a lens shift measuring apparatus 100 according to a first embodiment. FIG. 5 is a flowchart showing a flow of the operation of a lens shift measuring method according to the first embodiment. FIG. 9 is a schematic cross-sectional view showing an example of an optical module 150 that is manufactured by an optical module manufacturing method according to the first embodiment.

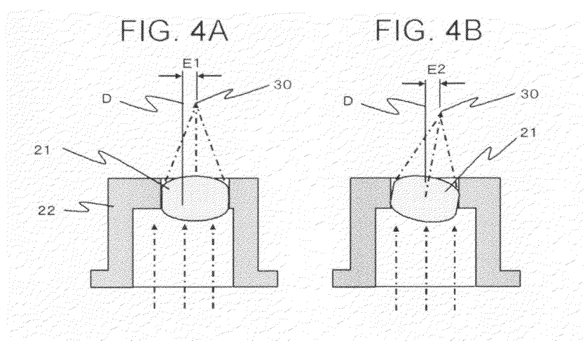

The lens shift measuring apparatus 100 according to the embodiment includes an irradiating unit (for example, configured using an epi-illumination light source 7 to illuminate epi-illumination light and a transmissive illumination light source 1 to illuminate transmissive illumination light) that irradiates light onto a lens-attached member (for example, lens cap 20) that has a lens 21 and a frame body (for example, cap 22) to hold the lens 21, such that a reflected light from the frame body and a focusing spot 30 (see FIGS. 4A and 4B) formed by focusing light transmitted through the lens 21 by the lens 21 is generated. The lens shift measuring apparatus 100 further includes an imaging unit (for example, color CCD camera 8) that includes the lens-attached member in an imaging range and an image processing unit (for example, color image processing unit 9) that calculates the shift of the lens 21 by executing image processing on an imaging result obtained by the imaging unit. The imaging unit images the returned light from the frame body and the light transmitted through the lens 21. In the image processing that is executed by the image processing unit, the following first to third processes are included. In the first process, the position of a predetermined portion (for example, center of a sheet-like portion 22a of the cap 22) in the frame body is calculated on the basis of an imaging result of the reflected light. In the second process, the position of the focusing spot 30 is calculated on the basis of an imaging result of the light transmitted through the lens 21. In the third process, a shift amount of the position of the focusing spot 30 with respect to the predetermined portion is calculated on the basis of the processing results of the first and second processes, as the shift of the lens 21.

In the lens shift measuring method according to the embodiment, the following first to third processes are executed. In the first process, the position of the predetermined portion (for example, center of the sheet-like portion 22a of the cap 22) in the frame body is calculated on the basis of the imaging result obtained by imaging the reflected light from the frame body, in a state in which the light is irradiated onto the lens-attached member (for example, lens cap 20) that has the lens 21 and the frame body (for example, cap 22) to hold the lens 21, such that the reflected light from the frame body is generated. In the second process, the position of the focusing spot 30 is calculated on the basis of the imaging result obtained by imaging the light transmitted through the lens 21, in a state in which the light is irradiated onto the lens-attached member, such that the focusing spot 30 formed by focusing the light transmitted through the lens 21 by the lens 21 is generated. In the third process, the shift amount of the position of the focusing spot 30 with respect to the predetermined portion is calculated as the shift of the lens 21.

In the optical module manufacturing method according to the embodiment, the following first to fourth processes are executed. In the first process, the position of the predetermined portion (for example, center of the sheet-like portion 22a of the cap 22) in the frame body is calculated on the basis of the imaging result obtained by imaging the reflected light from the frame body, in a state in which the light is irradiated onto the lens-attached member (for example, lens cap 20) that has the lens 21 and the frame body (for example, cap 22) to hold the lens 21, such that the reflected light from the frame body is generated. In the second process, the position of the focusing spot 30 is calculated on the basis of the imaging result obtained by imaging the light transmitted through the lens 21, in a state in which the light is irradiated onto the lens-attached member, such that the focusing spot 30 formed by focusing the light transmitted through the lens 21 by the lens 21 is generated. In the third process, a shift amount and a shift direction of the position of the focusing spot 30 with respect to the predetermined portion are calculated as the shift of the lens 21. In the fourth process, a stem 161 of a stem unit 153 that has the stem 161, a carrier 162 provided on the stem 161, and a light emitting element (for example, laser diode 163) provided on the carrier 162 and the frame body (for example, cap 22) of the lens-attached member (for example, lens cap 20) are bonded to each other. In the fourth process, the relative positions of the stem unit 153 and the lens-attached member are corrected, such that the shift amount calculated by the third process is corrected, and the stem 161 and the frame body are bonded to each other.

Hereinafter, the configuration of the first embodiment will be described in detail.

First, the configuration of the lens shift measuring apparatus 100 will be described.

As shown in FIG. 1, the lens shift measuring apparatus 100 according to the first embodiment includes a color CCD (Charge Coupled Device) camera 8 as the imaging unit, a color image processing unit 9, and an imaging lens unit 10.

The imaging lens unit 10 has an epi-illumination light source 7 that emits epi-illumination light (first light), a half mirror 6, and an imaging lens 5.

The lens shift measuring apparatus 100 further includes a mounting table 4 where a lens cap (lens-attached member) 20 is mounted, a transmissive illumination light source 1 that emits transmissive illumination light (second light), a pinhole plate 2 where a pinhole 2a is formed, and a collimator lens (converting unit) 3.

In this case, the lens cap 20 has a lens 21 and a cap 22 as a frame body to hold the lens 21.

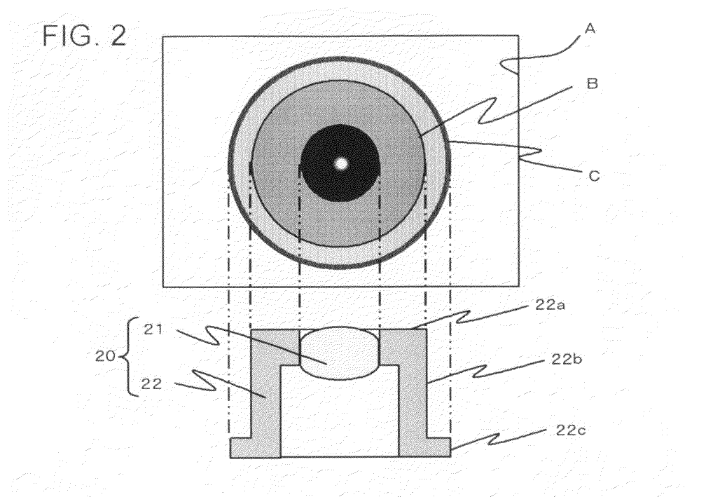

The cap 22 has a sheet-like portion 22a, a wall-like portion 22b, and a flange portion 22c, as shown in FIG. 2. The sheet-like portion 22a that is a substantially flat portion in the form of plate to hold the lens 21 at the center has a circular external shape. The wall-like portion 22b is formed in a tubular shape (for example, cylindrical shape) and has one end (upper end of FIG. 1) that is connected to a circumferential edge of the sheet-like portion 22a, such that its central axis is orthogonal to the sheet-like portion 22a. The flange portion 22c is a portion having a flange shape that is formed to protrude from the other end (lower end of FIG. 1) of the wall-like portion 22b to the outer circumferential side. The cap 22 is formed of a metal and substantially does not cause the epi-illumination light and the transmissive illumination light to pass through the cap.

The lens cap 20 is mounted on the mounting table 4. The mounting table 4 is formed of, for example, a transparent member such as a transparent resin or glass, and transmits the transmissive illumination light from the transmissive illumination light source 1. This mounting table 4 is disposed between the transmissive illumination light source 1, a pinhole plate 2, and the collimator lens 3 and the color

CCD camera 8. The lens cap 20 is mounted on the mounting table 4, such that the flange portion 22c becomes a lower portion and the sheet-like portion 22a and the lens 21 become an upper portion.

The pinhole 2a is disposed on a focus of the collimator lens 3. The pinhole 2a causes a portion of transmissive illumination light emitted from the transmissive illumination light source 1 to pass through the pinhole, thereby converging the transmissive illumination light. The collimator lens 3 converts the transmissive illumination light, which has passed through the pinhole 2a (which is converged by the pinhole 2a), into parallel light and causes the parallel light to be incident on the lens 21. That is, the collimator lens 3 converts the transmissive illumination light irradiated from the transmissive illumination light source 1 into the parallel light, before the transmissive illumination light reaches the lens 21. The transmissive illumination light source 1, the pinhole 2a, and the collimator lens 3 constitute a second irradiating unit.

In this case, the transmissive illumination light that is converted into the parallel light by the collimator lens 3 is irradiated over a sufficiently wide range to be incident on an entire surface of a bottom surface of the lens 21. That is, if the lens cap 20 is mounted on the mounting table 4 such that the lens cap 20 is within a field of view of the imaging lens unit 10, the transmissive illumination light that is converted into the parallel light by the collimator lens 3 is irradiated is incident on the entire surface of the bottom surface of the lens 21, regardless of arrangement of the lens cap 20 on the mounting table 4.

According to an ideal structure of the lens cap 20, an optical axis of the lens 21 is matched with a central axis of the tubular wall-like portion 22b. The transmissive illumination light source 1, the pinhole 2a, the collimator lens 3, the mounting table 4, and the lens cap 20 are disposed, such that the transmissive illumination light converted into the parallel light by the collimator lens 3 becomes light in a direction where an optical axis thereof is almost matched with the optical axis of the lens 21 of the lens cap 20 having the ideal structure. That is, the second irradiating unit (transmissive illumination light source 1, pinhole 2a, and collimator lens 3) irradiates the transmissive illumination light from a direction where almost straight view of the lens 21 is enabled.

However, due to a manufacturing error of the lens cap 20, the central position of the lens 21 may be shifted from the center of the sheet-like portion 22a or the lens 21 may be inclined with respect to the sheet-like potion 22a. When the lens 21 is mounted to be inclined with respect to the sheet-like portion 22a, the optical axis of the lens 21 is shifted from the optical axis of the transmissive illumination light that is converted into the parallel light by the collimator lens 3.

For example, the collimator lens 3 is disposed below the mounting table 4, the pinhole plate 2 is disposed on the lower side of the collimator lens 3, the transmissive illumination light source 1 is disposed on the lower side of the pinhole plate 2, and the transmissive illumination light source 1 emits (irradiates) the transmissive illumination light upward. In this case, an irradiation direction of the transmissive illumination light with respect to the lens 21 is the same as a direction in which light from the laser diode 163 is irradiated onto the lens 21, when the lens cap 20 is assembled as the optical module 150 (to be described below).

Meanwhile, the half mirror 6 reflects the epi-illumination light, which is emitted from the epi-illumination light source 7, to the side of the lens cap 20. The reflected light of the epi-illumination light is irradiated onto the lens cap 20 through the imaging lens 5. The epi-illumination light source 7, the half mirror 6, and the imaging lens 5 constitute the first irradiating unit.

In this case, the reflected light of the epi-illumination light is irradiated over a sufficiently wide range, such that the reflected light is irradiated onto an entire surface of the lens cap 20. That is, if the lens cap 20 is mounted on the mounting table 4 such that the lens cap 20 is within a field of view of the imaging lens unit 10, the reflected light of the epi-illumination light is irradiated onto the entire surface of the lens cap 20, regardless of arrangement of the lens cap 20 on the mounting table 4.

The epi-illumination light source 7, the half mirror 6, the imaging lens 5, the mounting table 4, and the lens cap 20 are disposed such that the reflected light of the epi-illumination light from the half mirror 6 is irradiated to be almost vertical to the sheet-like portion 22a of the lens cap 20. That is, the first irradiating unit (the epi-illumination light source 7, the half mirror 6, and the imaging lens 5) irradiates the epi-illumination light onto the lens cap 20, such that the epi-illumination light is irradiated to be almost vertical to the sheet-like portion 22a.

For example, the epi-illumination light source 7 emits (irradiates) the epi-illumination light in a horizontal direction (rightward direction of FIG. 1), the half mirror 6 is disposed on the side (right side in FIG. 1) of the epi-illumination light source 7 and reflects the epi-illumination light downward, the imaging lens 5 is disposed below the half mirror 6, and the mounting table 4 is disposed below the imaging lens 5.

In the case of this embodiment, the imaging lens unit 10 constitutes a coaxial epi-illumination optical system. That is, the imaging lens unit 10 has the imaging lens 5 and the half mirror 6 that is disposed between the imaging lens 5 and the color CCD camera 8. The imaging lens unit 10 is configured such that the epi-illumination light from the epi-illumination light source 7 is incident on the imaging lens 5 by the half mirror 6.

In this case, an irradiation direction of the epi-illumination light with respect to the lens cap 20 becomes a direction that is opposite to an irradiation direction of the transmissive illumination light. Thereby, the reflected (returned) light of the epi-illumination light from the sheet-like portion 22a and the transmissive illumination light transmitted through the lens 21 may be imaged by one color CCD camera 8 to be fixedly disposed.

The color CCD camera 8 images a color image of the lens cap 20 that is projected by the imaging lens unit 10. In the imaging lens unit 10, lens magnification is set such that a lens of the color CCD camera 8 is focused on a top surface (top surface of the sheet-like portion 22a) of the lens cap 20. The number of gray-scale levels of images that may be imaged by the color CCD camera 8 may be arbitrarily set. For example, the number of gray-scale levels may be 256 gray-scale levels, 128 gray-scale levels or 64 gray-scale levels for each color (for example, for each color of red, blue, and green).

To the color image processing unit 9, a color image of an imaging result obtained by the color CCD camera 8 is input. The color image processing unit 9 executes image processing on the color image imaged by the color CCD camera 8 and calculates the shift (eccentricity or inclination) of the lens 21 with respect to the sheet-like portion 22a.

In this case, the transmissive illumination light that is incident on the lens 21 is focused by the lens 21 and forms a focusing spot 30 (FIGS. 4A and 4B) above the lens 21.

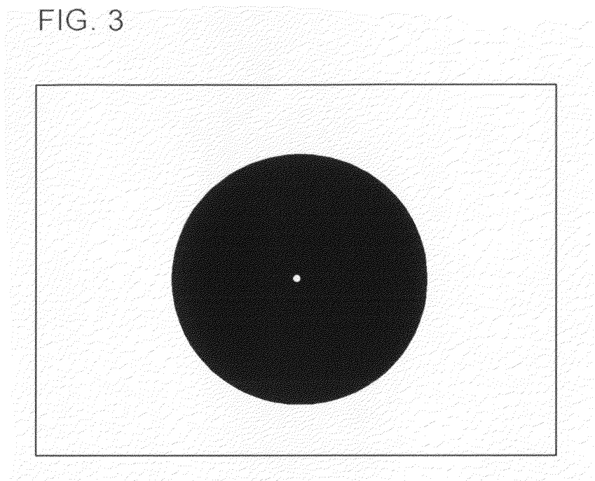

The color CCD camera 8 images an image (see FIG. 3) including the focusing spot 30, through the half mirror 6 and the imaging lens 5 of the imaging lens unit 10. That is, the imaging lens 5 images the transmissive illumination light transmitted through the lens 21, in the color CCD camera 8.

Meanwhile, the epi-illumination light that is irradiated onto the lens cap 20 is reflected on a top surface of the sheet-like portion 22a.

The color CCD camera 8 images an image (see FIG. 2) including the reflected (returned) light from the sheet-like portion 22a, through the half mirror 6 and the imaging lens 5 of the imaging lens unit 10. That is, the imaging lens 5 images the epi-illumination light reflected from the sheet-like portion 22a, in the color CCD camera 8.

In the case of the embodiment, the wavelengths of the transmissive illumination light irradiated from the transmissive illumination light source 1 and the epi-illumination light irradiated from the epi-illumination light source 7 are different from each other. The reflected light of the epi-illumination light from the lens cap 20 and the transmissive illumination light including the focusing spot 30 are imaged by the color CCD camera 8 at one time. The color CCD camera 8 outputs a color image corresponding to an imaging result to the color image processing unit 9. The color image processing unit 9 executes filter processing on the color image, thereby extracting an image (hereinafter, referred to as transmissive illumination image) based on the transmissive illumination light and an image (hereinafter, referred to as epi-illumination image) based on the epi-illumination light.

The color image processing unit 9 executes image processing on the epi-illumination image and calculates the position of a predetermined portion (for example, center of the sheet-like portion 22a of the cap 22) of the cap 22. Meanwhile, the color image processing unit 9 executes image processing on the transmissive illumination image and calculates the position of the focusing spot 30 of the transmissive illumination light that is focused by the lens 21. The color image processing unit 9 calculates a shift amount and a shift direction of the position of the focusing spot 30 with respect to the central position of the sheet-like portion 22a.

Next, the operation will be described. The operation description also corresponds to the description of a lens shift measuring method according to the embodiment.

In the embodiment, first, the transmissive illumination light is irradiated from the transmissive illumination light source 1 and the epi-illumination light is irradiated from the epi-illumination light source 7.

In this state, the transmissive illumination light that is irradiated from the transmissive illumination light source 1 is converged by the pinhole 2a and is converted into parallel light by the collimator lens 3. The reason why the transmissive illumination light is caused to pass through the pinhole 2a is that a light source diameter of the illumination light source is generally large and it is difficult to obtain parallel light with high precision by only the collimator lens 3. Letting the transmissive illumination light through the pinhole 2a disposed on the focus of the collimator lens 3, the transmissive illumination light can be converted into the parallel light with high precision.

The transmissive illumination light that is converted into the parallel light by the collimator lens 3 transmits the mounting table 4 and is irradiated onto the lens cap 20, from the lower side. The transmissive illumination light passes through the inside of the wall-like portion 22b of the lens cap 20, is incident on the lens 21 from the lower side, is focused by the lens 21, and forms the focusing spot (see FIGS. 4A and 4B) above the lens 21.

In this case, the focal distance of the lens 21 of the lens cap 20 that is used in packaging of the optical semiconductor element is generally short in a high-performance optical module (for example, the lens 21 is an aspherical lens made of a material with a high refractive index) where high coupling efficiency is required at the high speed and the long transmission distance, for example, less than 1 mm at most. For this reason, the focusing spot 30 of the transmissive illumination light that is formed by the lens 21 is positioned within the distance less than 1 mm at most, above the lens 21, and the height difference between the focusing spot 30 and the top surface of the cap 22 is within a depth of field of the imaging lens unit 10. For this reason, if the color CCD camera 8 performs imaging through the imaging lens unit 10, the color CCD camera 8 can focus the lens on the focusing spot 30 while focusing the lens on the top surface of the sheet-like portion 22a of the cap 22 and can perform imaging. That is, in the embodiment, the lens cap 20 (for example, the lens 21 is an aspherical lens made of a material with a high refractive index) where the focal distance of the lens 21 is short is set as a measurement object.

The lens 21 of the lens cap 20 is designed to be optimized in a near-infrared region corresponding to the wavelength of the laser diode. In this case, the wavelength of the transmissive illumination light from the transmissive illumination light source 1 is also preferably the wavelength (red color in the case of a visible light region) close to near infrared rays. If the wavelength (color) of the transmissive illumination light is set as a red color, the wavelength (color) of the epi-illumination light from the epi-illumination light source 7 is preferably set as a green color or a blue color.

Meanwhile, the epi-illumination light that is irradiated from the epi-illumination light source 7 is reflected to the side of the lens cap 20 (lower side) by the half mirror 6, and is irradiated onto the lens cap 20 through the imaging lens 5. The epi-illumination light is reflected on the top surface of the lens cap 20 and is imaged on an imaging surface of the color CCD camera 8 though the imaging lens 5 and the half mirror 6. That is, the color CCD camera 8 images the entire lens cap 20 through the imaging lens unit 10, by the epi-illumination light.

The outer diameter of the cap 22 that is used in a standard package of the optical semiconductor element is about 3 to 4 mm. An imaging surface of the color CCD camera 8 that is generally on the market has a rectangular shape in which the length of one side is about 5 to 8 mm. For this reason, optical magnification of the imaging lens unit 10 is set to about 1 to 2×.

In the case of the embodiment, the color CCD camera 8 acquires an image where illumination light of both the transmissive illumination light source 1 and the epi-illumination light source 7 is synthesized as a color image by one-time imaging. The image that is obtained by the imaging is output to the color image processing unit 9. In the case of the embodiment, an image based on only the transmissive illumination light from the transmissive illumination light source 1 and an image based on only the epi-illumination light from the epi-illumination light source 7 are extracted by filter processing in the color image processing unit 9.

An image in a frame A of FIG. 2 is an image that is extracted with a color of the epi-illumination light. Since a correspondence relationship between the image in the frame A and the individual unit of the lens cap 20 is shown outside the frame A of FIG. 2, a sectional shape of the lens cap 20 is shown.

Since the image lens unit 10 is focused on the top surface of the sheet-like portion 22a of the cap 22, a circular edge (outline B) of the top surface of the sheet-like portion 22a can be clearly observed. Meanwhile, since the imaging lens unit 10 is not focused on the top surface of the flange portion 22c of the cap 22, an edge thereof (outline C) is unclear. Since an outer shape of the lens 21 is a curved surface, the reflected light of the epi-illumination light is not returned from most of the lens 21. For this reason, an image that corresponds to the lens 21 is viewed dark as a whole. Since a central portion of the lens 21 is almost orthogonal to the optical axis of the epi-illumination light, the reflected light is returned from the central portion and an image corresponding to the central portion becomes a bright point. However, when the lens 21 is inclined to the cap 22, the bright point is shifted from the position of the focusing spot 30 formed by focusing the light by the lens 21. For this reason, it is not preferable to measure the eccentricity of the lens 21 on the basis of the position of the bright point.

In the embodiment, the positions of plural points in a clear circular edge (outline B) of the top surface of the sheet-like portion 22a of the cap 22 are detected, and the central position of the sheet-like portion 22a of the lens cap 20 is calculated on the basis of the detected positions of the plural points (which will be described in detail below).

FIG. 3 shows an image that is extracted with a color of the transmissive illumination light from the transmissive illumination light source 1. The cap 22 is formed of a metal and does not transmit the transmissive illumination light. Meanwhile, the transmissive illumination light that has passed through the lens 21 is focused by the lens 21 and forms the focusing spot 30 (refer to FIGS. 4A and 4B) above the lens 21. An image that corresponds to the focusing spot 30 becomes a small bright point (white portion of a central portion of FIG. 3).

The color image processing unit 9 detects the deviation (shift) of the position of the spot position (white portion of the central portion of FIG. 3) of the transmissive illumination light and the central position of the lens cap 20 described above as the shift of the lens 21 of the lens cap 20.

FIGS. 4A and 4B are schematic front cross-sectional views of the lens cap 20 showing the position shift of the focusing spot 30 caused by the shift of the lens 21.

FIG. 4A shows a state in which the lens 21 is eccentric horizontally with respect to the cap 22. If the parallel transmissive illumination light is irradiated from the lower side of the lens cap 20, the transmissive illumination light is focused by the lens 21 and forms the focusing spot 30.

The position of the focusing spot 30 is shifted from the center D of the sheet-like portion 22a of the cap 22 by the amount of eccentricity E1 of the lens 21. In this case, the lens vertex (position of a central bright point of the lens 21 shown in FIG. 2) where a curved surface of the lens 21 becomes horizontal and the position of the focusing spot 30 formed by the lens 21 are matched with each other.

FIG. 4B shows a state in which the lens 21 is inclined with respect to the cap 22. The position of the focusing spot 30 of the transmissive illumination light that is focused by the lens 21 is horizontally shifted from the center D of the sheet-like portion 22a of the cap 22 by the shift amount E2 according to the inclination of the optical axis of the lens 21. In this case, the vertex of the lens 21 and the position of the focusing spot 30 formed by the lens 21 are not matched with each other.

The lens shift measuring apparatus 100 according to the embodiment measures a shift amount and a shift direction of the position of the focusing spot 30 to suppress the position shift of the focusing spot of the laser diode 163, when the laser diode 163 is sealed by the lens cap 20. If this point is considered, it is important to be able to measure the position shift of the focusing spot 30 due to the inclination of the lens 21 as well as the position shift of the focusing spot 30 due to the eccentricity of the lens 21. According to the lens shift measuring apparatus 100 according to the embodiment, since the position of the focusing spot 30 formed by focusing the transmissive illumination light by the lens 21 is detected, the position shift of the focusing spot 30 due to the inclination of the lens 21 can be easily measured.

Next, a flow of image processing for calculating the shift of the lens 21 from the obtained image will be described with reference to a flowchart of FIG. 5.

The image processing shown in FIG. 5 includes processes of steps S1 to S8 to be described below. In step S1, a color image of the lens cap 20 where the transmissive illumination light and the epi-illumination light are irradiated is imaged by the color CCD camera 8, and the color image of the lens cap 20 that is obtained by the imaging is output from the color CCD camera 8 to the color image processing unit 9. The processes of steps S2 to S8 are executed by the color image processing unit 9. First, instep S2, the color image that is imaged in step S1 is positioned. In step S3, only a color of the epi-illumination light is extracted from the color image positioned in step S2. In step S4, an edge of the top surface of the sheet-like portion 22a of the cap 22 is detected from the image extracted with the color of the epi-illumination light in step S3. In step S5, the central position (that is, central position of the sheet-like portion 22a) of a circular shape that is formed by the edge detected in step S4 is calculated. In step S6, only a color of the transmissive illumination light is extracted from the color image that is positioned in step S2. In step S7, the position of the focusing spot 30 of the transmissive illumination light that is focused by the lens 21 is detected from the image extracted with the color of the transmissive illumination light in step S6. In step S8, a shift amount and a shift direction of the position of the lens 21 with respect to the central position of the sheet-like portion 22a are calculated from the central position of the sheet-like portion 22a of the cap 22 obtained in step S5 and the position of the focusing spot 30 obtained in step S7.

Hereinafter, the processes of steps S2 to S8 that are executed by the color image processing unit 9 will be described in detail.

In step S2, the image of the lens cap 20 that is imaged in step S1 is positioned. The positioning is performed to accurately dispose windows (region to execute image processing) disposed in an image in the following processes with respect to the image of the lens cap 20 to some degree. This positioning is performed using a method, such as pattern matching.

In the pattern matching, for example, correlation values of a reference image previously stored and held by the color image processing unit 9 and the image of the lens cap 20 obtained by imaging are calculated, and similarity of both the images is calculated. For example, a correlation value with the reference image at each position is calculated while the image of the lens cap 20 obtained by the imaging is sequentially moved little by little, and the image of the lens cap 20 obtained by the imaging is positioned at the position where both the images are most matched with each other.

Next, in step S3, filter processing for extracting an image of a color of the epi-illumination light from the image of the lens cap 20 positioned in the previous step S2 is executed. By this processing, the image that is shown in the frame A of FIG. 2 is obtained.

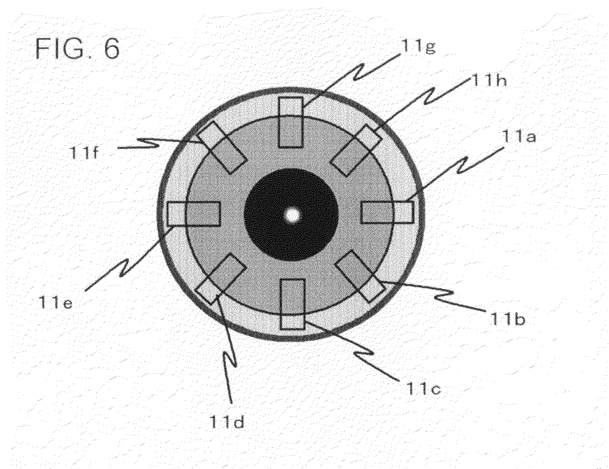

FIG. 6 shows image processing for calculating the central position of the sheet-like portion 22a of the lens cap 20, which shows a state in which three or more windows (for example, eight windows 11a to 11h) are disposed in the image.

In step S4, as shown in FIG. 6, the windows 11a to 11h are disposed in three places or more (in the embodiment, 8 places) in an outer circumferential portion of the sheet-like portion 22a of the cap 22 to the image obtained in the previous step S3. In each of the windows 11a to 11h, a portion that becomes brighter from the center of the lens cap 20 to the outside is detected as the edge of the sheet-like portion 22a.

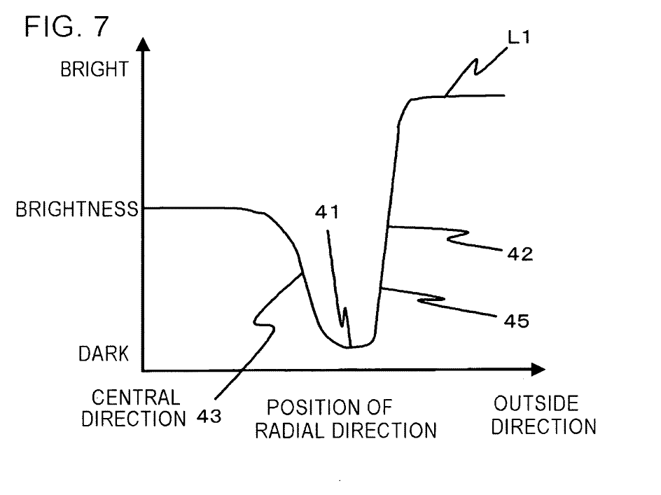

A curved line L1 shown in FIG. 7 shows an example of a change curved line of brightness of an image in a radial direction of the sheet-like portion 22a. That is, the curved line L1 shows an example of a change in the brightness of an image from the central side of the sheet-like portion 22a to the outside, in any one of the windows 11a to 11h of FIG. 6.

In FIG. 2, a portion (outline B) that is viewed dark in a circular shape along outer circumference of the sheet-like portion 22a corresponds to a portion 41 that becomes dark in the curved line L1 of FIG. 7. The edge of the sheet-like portion 22a corresponds to a portion 42 that becomes brighter in the curved line L1 of FIG. 7. In order to accurately detect the portion 42 corresponding to the edge of the sheet-like portion 22a, differentiation is performed on the curved line L1 as will be described below.

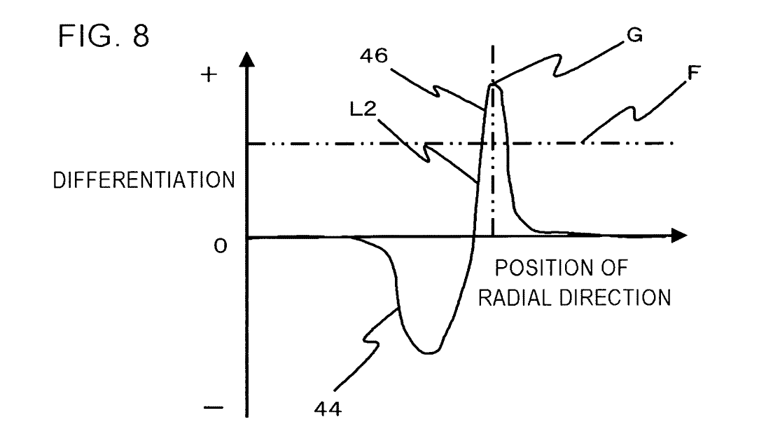

A curved line L2 shown in FIG. 8 is a curved line that is obtained by performing primary differentiation on the curved line L1 of FIG. 7 in a radial direction.

The curved line L2 of FIG. 8 becomes negative in a portion 44 (FIG. 8) that corresponds to a portion 43 (FIG. 7) where brightness negatively changes (becomes dark) in the curved line L1 of FIG. 7, and becomes positive in a portion 46 (FIG. 8) that corresponds to a portion 45 (FIG. 7) where brightness positively changes (becomes bright).

In order to detect the portion 42 (edge of the sheet-like portion 22a) that becomes brighter in FIG. 7, for example, in FIG. 8, a threshold value F is set, it is determined whether a differential value becomes maximized or a secondary differential value becomes zero in a region where a value becomes equal to or more than the threshold value F, and the edge position G of the sheet-like portion 22a is calculated.

By determine the edge position G for each of the windows 11a to 11h in FIG. 6, three or more (for example, eight) edge positions G that are different from each other can be calculated. The edge positions G are arranged in a circular shape along outer circumference of the sheet-like portion 22a.

In step S5, the central position of the sheet-like portion 22a of the cap 22 is calculated on the basis of the three or more (for example, eight) edge positions G detected in the previous step S4. Since a minimum of three edge positions G are needed to calculate the center of the circle from the edge positions G on the circumference, the number of windows that is set in step S4 is three minimum. When the number of windows is equal to or more than four, an approximate circle may be calculated from each edge position G using a least-square method and the center thereof may be used as the center of the sheet-like portion 22a of the cap 22. In step S4, if the number of windows to detect the edge positions G is increased, improvement of measurement precision of the central position of the sheet-like portion 22a may be expected by an averaging effect.

Meanwhile, in step S6, filtering process for extracting an image of a color of the transmissive illumination light from the image of the lens cap 20 positioned in the previous step S2 is executed. By this processing, for example, an image shown in FIG. 3 is obtained.

In the image based on the transmissive illumination light shown in FIG. 3, only the focusing spot 30 (see FIGS. 4A and 4B) of the transmissive illumination light that is focused by the lens 21 shines bright. For this reason, in step S7 subsequent to step S6, the position of the focusing spot 30 can be easily detected using general pattern matching or gravity center calculation. That is, the position of the focusing spot 30 with respect to the edge position G can be detected using the plural edge positions G calculated in the previous step S4.

The processes of steps S3 to S5 and the processes of steps S6 and S7 may be executed at individual timings or may be executed in parallel in a temporal sequence.

In step S8, on the basis of the central position of the sheet-like portion 22a of the cap 22 calculated in the previous step S5 and the position of the focusing spot 30 calculated in the previous step S7, a position shift amount and a position shift direction of the focusing spot 30 with respect to the central position are calculated.

A series of image processing of steps S2 to S8 may be perfectly realized by functions of a general-purpose image processing apparatus that is generally on the market.

Next, before an optical module manufacturing method according to the embodiment is described, the configuration of the optical module 150 will be described with reference to FIG. 9.

As shown in FIG. 9, the optical module 150 has a CAN package 151 and a receptacle 152.

The CAN package 151 has a stem 161, a carrier 162, a laser diode 163 as a light emitting element, and the lens cap 20. On a mounting surface 161A of the stem 161, a block 165 is formed to protrude from the mounting surface 161A. On a side of the block 165, the carrier 162 is fixed. The carrier 162 is an insulating substrate on which the laser diode 163 is mounted. On the carrier 162, the laser diode 163 is fixed. As such, when the carrier 162 and the laser diode 163 are mounted on the block 165, the position of the block 165 is designed such that a light emission point of the laser diode 163 is positioned at the center of the mounting surface 161A. The laser diode 163 irradiates laser light 164 in a direction orthogonal to the mounting surface 161A of the stem 161. The components (the carrier 162 and the laser diode 163) on the stem 161 are hermetic sealed by the lens cap 20.

The receptacle 152 has a tubular fixing portion 171 and an optical connector inserting portion 172. The optical connector inserting portion 172 is formed in a cylindrical joint shape. In an inner portion of the optical connector inserting portion 172, for example, an SMF (Single Mode Fiber) stub 173 is inserted and fixed. If an optical connector 180 is inserted into the optical connector inserting portion 172 and a front end of the optical connector 180 is bumped against a right end face of the SMF stub 173 in FIG. 9, the optical connector 180 may be positioned in the optical connector inserting portion 172. In a positioning state, an optical fiber 181 in the optical connector 180 and an SMF (Single Mode Fiber) 174 in the SMF stub 173 are coaxially positioned.

Next, the optical module manufacturing method according to the embodiment will be described.

First, the lens cap 20 described above is prepared. Next, the shift amount and the shift direction of the position of the focusing spot 30 with respect to the central position are calculated as the shift of the lens 21 with respect to the central position of the sheet-like shape 22a of the cap 22 of the lens cap 20, using the lens shift measuring method described above.

When the lens cap 20 is mounted at the defined position of the stem 161, the shift amount and the shift direction are matched or correlated with a shift amount and a shift direction in which a focusing spot (not shown in the drawings) formed by focusing the irradiated light from the laser diode 163 by the lens 21 is shifted from the central position of the sheet-like portion 22a.

Meanwhile, the stem unit 153 is previously configured by fixing the carrier 162 on the stem 161 and mounting the laser diode 163 on the carrier 162.

Next, the relative positions of the stem unit 153 and the lens cap 20 are corrected (corrected from the defined position described above) such that the shift amount calculated by the lens shift measuring method is corrected, and the components (the carrier 162 and the laser diode 163) on the stem 161 are hermetic sealed by the lens cap 20. That is, the stem unit 153 and the lens cap 20 are bonded to each other, in a state in which the position of the lens cap 20 with respect to the stem unit 153 is corrected from the defined position by the same amount (distance) as the calculated shift amount in a direction opposite to the calculated shift direction. Specifically, the stem 161 and the flange portion 22c of the cap 22 are bonded by resistance welding. Thereby, the CAN package 151 that has the stem unit 153 and the lens cap 20 is configured.

Next, the optical connector 180 is inserted into the optical connector inserting portion 172 of the receptacle 152 and the optical fiber 181 in the optical connector 180 is aligned to the laser diode 163. In this case, since the position of the focusing spot 30 formed by focusing the irradiated light from the laser diode 163 by the lens 21 is corrected in advance, the aligning can be easily performed, and optical coupling efficiency of the laser diode 163 and the receptacle 152 (SMF stub 173 of the receptacle 152) can be sufficiently obtained.

Next, the receptacle 152 and the CAN package 151 are mutually fixed at the aligned positions. The CAN package 151 is fixed to inner circumference of the tubular fixing portion 171 of the receptacle 152 by adhesion with an adhesive agent.

In this way, the optical module 150 can be manufactured.

According to the first embodiment described above, the central position in the sheet-like portion 22a may be calculated on the basis of the imaging result of the epi-illumination light that is reflected from the sheet-like portion 22a of the lens cap 20, the position of the focusing spot 30 of the transmissive illumination light by the lens 21 may be calculated on the basis of the imaging result of the transmissive illumination light transmitted through the lens 21, and the shift amount and the shift direction of the position of the focusing spot 30 with respect to the center of the sheet-like portion 22a may be calculated on the basis of the calculated positions.

Accordingly, the shift amount and the shift direction of the position of the focusing spot 30 due to the shift of the lens 21 (eccentricity or inclination of the lens 21 with respect to the cap 22) may be calculated without rotating the lens cap 20. That is, a rotating mechanism that rotates the lens cap 20 is unnecessary, and the shift amount and the shift direction of the position of the focusing spot 30 due to the eccentricity or the inclination of the lens 21 with respect to the cap 22 may be calculated using an apparatus having the simple configuration.

Instead of measuring the lens eccentricity from the trace of the center of the lens when the lens is rotated, the image of the lens cap 20 is processed and the shift of the lens 21 is measured from the central position of the sheet-like portion 22a of the cap 22 and the position of the focusing spot 30. Therefore, a high-speed measurement is enabled and the shift direction as well as the shift amount can be easily calculated.

That is, imaging does not need to be performed over plural times in the course of rotating the lens cap 20, and only one-time imaging may be performed in a state in which the position of the lens cap 20 is fixed. For this reason, the shift amount and the shift direction of the position of the focusing spot 30 can be measured in short time. Since the position of the focusing spot 30 of the transmissive illumination light focused by the lens 21 is calculated on the basis of the imaging result of the transmissive illumination light transmitted through the lens 21, the position shift of the focusing spot 30 due to the inclination of the lens 21 may be also calculated.

Specifically, since the position of the focusing spot 30 formed by focusing the transmissive illumination light corresponding to the parallel light by the lens 21 is calculated, the shift amount of the focusing spot 30 due to the inclination of the optical axis of the lens 21 can be accurately measured, even when the lens 21 is inclined with respect to the cap 22.

In the lens shift measuring apparatus 100 according to the embodiment, one object is to reduce the position shift of the focusing spot by the laser light 164 emitted from the laser diode 163 in the optical module 150 when the lens cap 20 is assembled as the optical module 150. For this reason, it is important to accurately measure the shift amount of the position of the focusing spot 30 due to the inclination of the lens 21 and the shift amount of the position. In the case of the lens cap 20 where an aspheric lens aiming at high optical coupling efficiency is used as the lens 21, since a decrease in the optical coupling efficiency due to the shift of the light emission point of the laser diode 163 from the optical axis of the lens 21 is notable, the position of the lens 21 needs to be strictly managed. In the embodiment, since the position shift amount of the focusing spot 30 can be accurately measured, position correction of the lens 21 when the CAN package 151 is hermetic sealed by the lens cap 20 can be accurately performed. Therefore, sufficient optical coupling efficiency can be obtained even when the lens 21 is the aspheric lens.

As such, the shift amount of the position of the focusing spot 30 of the lens 21 due to the eccentricity of the lens 21 with respect to the cap 22 and the shift amount of the position of the focusing spot 30 of the lens 21 due to the inclination of the lens 21 with respect to the cap 22 may be calculated in short time using the lens shift measuring apparatus 100 having the simple configuration.

The transmissive illumination light is converted into the parallel light by the pinhole 2a and the collimator lens 3 and is irradiated over a sufficiently wide range as described above. And the epi-illumination light is also irradiated over a sufficiently wide range as described above. For this reason, if the lens cap 20 is disposed in a field of view of the imaging lens unit 10, the measured shift amount is not affected by the position. Accordingly, a positioning mechanism that accurately positions the lens cap 20 at the predetermined position is not needed.

The wavelengths of the transmissive illumination light and the epi-illumination light are set to be different from each other, the color image of the lens cap 20 is imaged by the color CCD camera 8 in a state where the transmissive illumination light and the epi-illumination light are irradiated, and the image based on the transmissive illumination light and the image based on the epi-illumination light are extracted from the color image, using the color image processing unit 9. By executing image processing on the extracted images, the position of the focusing spot 30 and the central position in the sheet-like portion 22a are calculated. Accordingly, since the transmissive illumination light and the epi-illumination light do not need to be switched, a control device for switching is not needed, and the lens shift measuring apparatus 100 can be configured at a low cost. Since only one-time imaging may be performed, an imaging time can be reduced.

### Second Embodiment

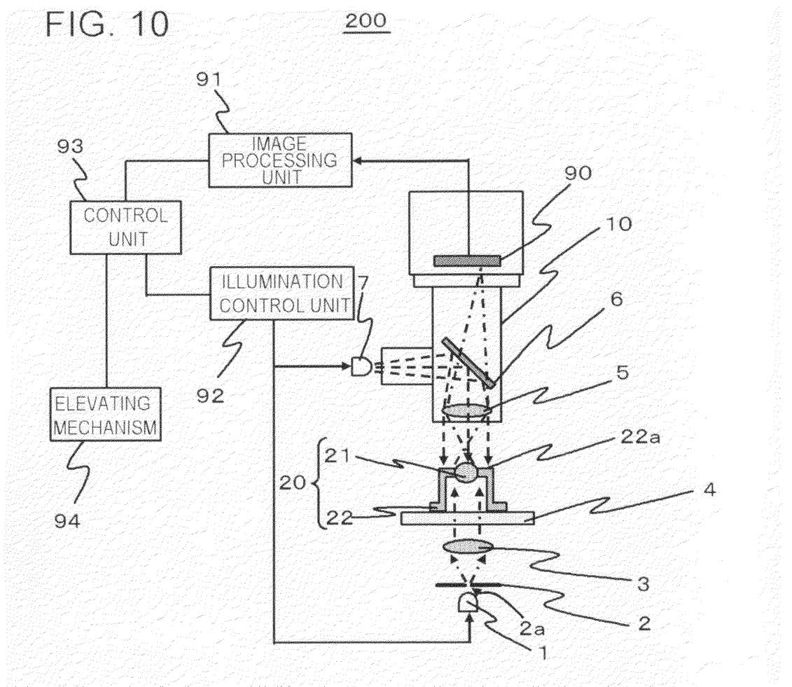

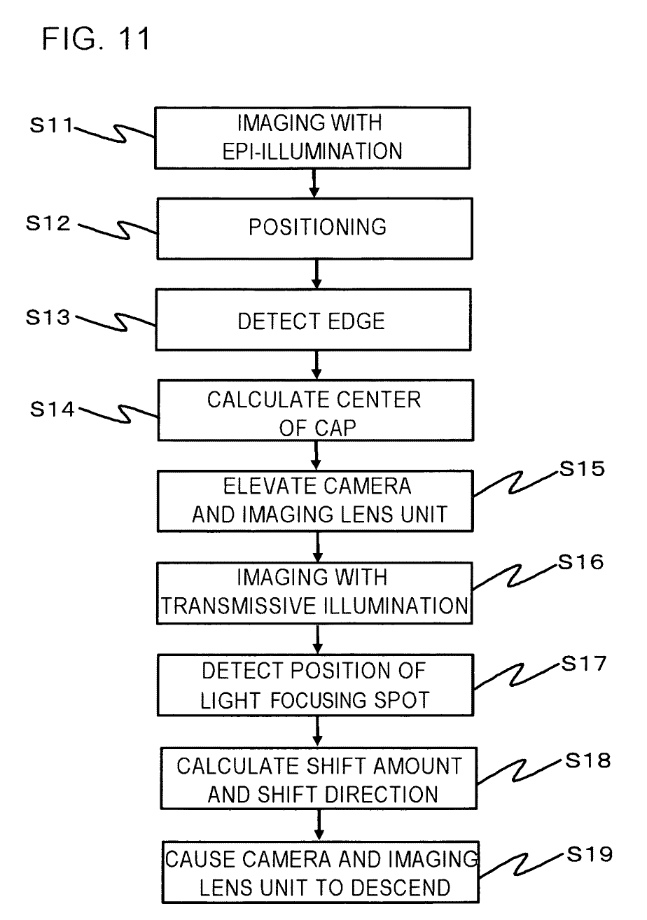

FIG. 10 is a schematic front cross-sectional view of a lens shift measuring apparatus 200 according to a second embodiment. FIG. 11 is a flowchart showing a flow of the operation of a lens shift measuring method according to the second embodiment.

In the first embodiment, the example of the case where the wavelengths of the epi-illumination light and the transmissive illumination light are set to be different from each other, the image of the color of the epi-illumination light and the image of the color of the transmissive illumination light are extracted from the color image obtained by one-time imaging, and the image processing is executed respectively, has been described. Meanwhile, in the second embodiment, an example of the case where imaging based on the epi-illumination light and imaging based on the transmissive illumination light are performed at different timings will be described.

In the case of the embodiment, the wavelengths of the epi-illumination light from the epi-illumination light source 7 and the transmissive illumination light from the transmissive illumination light source 1 do not need to be different from each other. The wavelengths of the epi-illumination light and the transmissive illumination light maybe equal to each other or different from each other.

In the case of the embodiment, the lens shift measuring apparatus 200 includes a CCD camera 90, instead of the color CCD camera 8 (refer to FIG. 1). The CCD camera 90 does not need to image a color image and may image a monochrome image. The number of gray-scale levels of images that may be imaged by the CCD camera 90 is arbitrary, and may be, for example, 256 gray-scale levels, 128 gray-scale levels or 64 gray-scale levels.

In the case of the embodiment, the lens shift measuring apparatus 200 has an image processing unit 91, instead of the color image processing unit 9. The image processing unit 91 does not need to process a color image and may process a monochrome image.

The lens shift measuring apparatus 200 according to the embodiment further includes a control unit 93, an illumination control unit 92, and an elevating mechanism 94.

The control unit 93 controls the operation of the image processing unit 91, the illumination control unit 92, and the elevating mechanism 94.

The illumination control unit 92 individually turns on/off the transmissive illumination light source 1 and the epi-illumination light source 7, under the control of the control unit 93.

In this case, the CCD camera 90 and the imaging lens unit 10 are mutually integrally provided. For example, the elevating mechanism 94 relatively elevates the CCD camera 90 and the imaging lens unit 10 with respect to the mounting table 4. The elevating mechanism 94 may be configured to change the distances of the CCD camera 90 and the imaging lens unit 10 and the mounting table 4 in a vertical direction. For example, the elevating mechanism 94 may be configured to elevate the mounting table 4 or configured to elevate the CCD camera 90 and the imaging lens unit 10 and the mounting table 4 respectively.

In the case of the embodiment, an image of the lens cap 20 is imaged by the CCD camera 90 through the imaging lens unit 10. The CCD camera 90 outputs an image of an imaging result to the image processing unit 91. The image processing unit 91 executes image processing on the image input from the CCD camera 90.

In the first embodiment described above, the lens cap 20 (for example, the lens 21 is an aspherical lens made of a material with a high refractive index) where the focal distance of the lens 21 is short is set as the measurement object. Meanwhile, in the second embodiment, the lens cap 20 (for example, the lens 21 is a cheap ball lens made of a material with a common refractive index) where the focal distance of the lens 21 is long may be set as the measurement object. That is, in the case of the lens cap 20 where the focal distance of the lens 21 is long, the height difference between the focusing spot 30 and the top surface of the cap 22 may be out of a depth of field of the image lens unit 10. However, if the elevating mechanism 94 is used to elevate the imaging lens unit 10 and the CCD camera 90 to the position where the lens is focused on the focusing spot 30, the focusing spot 30 can be clearly imaged.

Hereinafter, the operation of the embodiment will be described with reference to FIG. 11. The operation description also corresponds to the description of a lens shift measuring method according to the embodiment.

First, the control unit 93 transmits a control signal, which instructs to turn off the transmissive illumination light source 1 and turn on the epi-illumination light source 7, to the illumination control unit 92. The illumination control unit 92 that receives the control signal turns off the transmissive illumination light source 1 and turns on the epi-illumination light source 7. Accordingly, the epi-illumination light that is emitted from the epi-illumination light source 7 is irradiated onto the lens cap 20 through the half mirror 6 and the imaging lens 5. In this stage, the vertical positions of the imaging lens unit 10 and the CCD camera 90 are controlled such that the lens of the CCD camera 90 of the imaging lens unit 10 is focused on the top surface (top surface of the sheet-like portion 22a) of the lens cap 20.

In this state, the control unit 93 transmits a first trigger signal to the image processing unit 91. The image processing unit 91 that receives the first trigger signal acquires an image that is imaged by the CCD camera 90. That is, when the CCD camera 90 is of a digital output type, the image processing unit 91 transmits an imaging command to the CCD camera 90, and the CCD camera 90 that receives the imaging command images an image of the lens cap 20, generates image data, and outputs the generated image data to the image processing unit 91. Meanwhile, when the CCD camera 90 is a type of an analog output, the image processing unit 91 converts an analog video signal, which is input from the CCD camera 90, into image data, and obtains the image data (step S11).

Next, the image processing unit 91 executes processes of steps S12 to S14.

First, in step S12, the image of the lens cap 20 that is imaged in the previous step S11 is positioned, similarly to the process of step S2 (FIG. 5) in the first embodiment.

Next, in step S13, the edge position of the sheet-like portion 22a of the cap 22 is detected, similarly to the process of step S4 (FIG. 5) in the first embodiment.

Next, in step S14, the central position of the sheet-like portion 22a of the cap 22 is calculated, similarly to the process of step S5 (FIG. 5) in the first embodiment.

Next, the control unit 93 transmits a command to the elevating mechanism 94. Next, the elevating mechanism 94 elevates the imaging lens unit 10 and the CCD camera 90 to the position where the lens is focused on the focusing spot 30 (step S15).

Next, the control unit 93 transmits a control signal, which instructs to turn on the transmissive illumination light source 1 and turn off the epi-illumination light source 7, to the illumination control unit 92. The illumination control unit 92 that receives the control signal turns on the transmissive illumination light source 1 and turns off the epi-illumination light source 7. Accordingly, the transmissive illumination light that is emitted from the transmissive illumination light source 1 is incident on the lens 21 through the pinhole 2a and the collimator lens 3, and the transmissive illumination light is focused by the lens 21 and the focusing spot 30 is formed above the lens 21.

In this state, the control unit 93 transmits a second trigger signal to the image processing unit 91. The image processing unit 91 that receives the second trigger signal acquires an image that is imaged by the CCD camera 90 (step S16).

Next, the image processing unit 91 executes processes of steps S17 and S18.

First, in step S17, the position of the focusing spot 30 is calculated, similarly to the process of step S7 (FIG. 5) in the first embodiment.

Next, in step S18, the shift amount and the shift direction of the position of the focusing spot 30 with respect to the central position of the sheet-like portion 22a of the cap 22 are calculated, similarly to the process of step S8 (FIG. 5) in the first embodiment.

Next, in step S19, the control unit 93 transmits a command to the elevating mechanism 94. Next, the elevating mechanism causes the imaging lens unit 10 and the CCD camera 90 to descend to the position where the lens is focused on the top surface of the cap 22 (step S15).

In the embodiment, similarly to the first embodiment, the lens cap 20 (for example, the lens 21 is an aspherical lens made of a material with a high refractive index) where the focal distance of the lens 21 is short may be set as the measurement object. When such lens cap 20 is set as the measurement object, among the above-described processes, the processes of steps S15 and S19 may not be executed. If only such lens cap 20 is set as the measurement object, the lens shift measuring apparatus 200 that does not have the elevating mechanism 94 may be configured.

Since the optical module manufacturing method according to the embodiment is the same as that of the first embodiment, the description will not be repeated.

According to the second embodiment described above, the same effect as that of the first embodiment may be obtained. In addition, the illumination control unit 92 is used to switch the irradiation of the transmissive illumination light from the transmissive illumination light source 1 and the irradiation of the epi-illumination light from the epi-illumination light source 7 in a temporal sequence, and the central position of the sheet-like portion 22a of the cap 22 and the position of the focusing spot 30 are calculated from the individual image data. Therefore, the CCD camera 90 and the image processing unit 91 may use a monochrome type, instead of a color type, and the CCD camera 90 and the image processing unit 91 may be manufactured at a low cost.

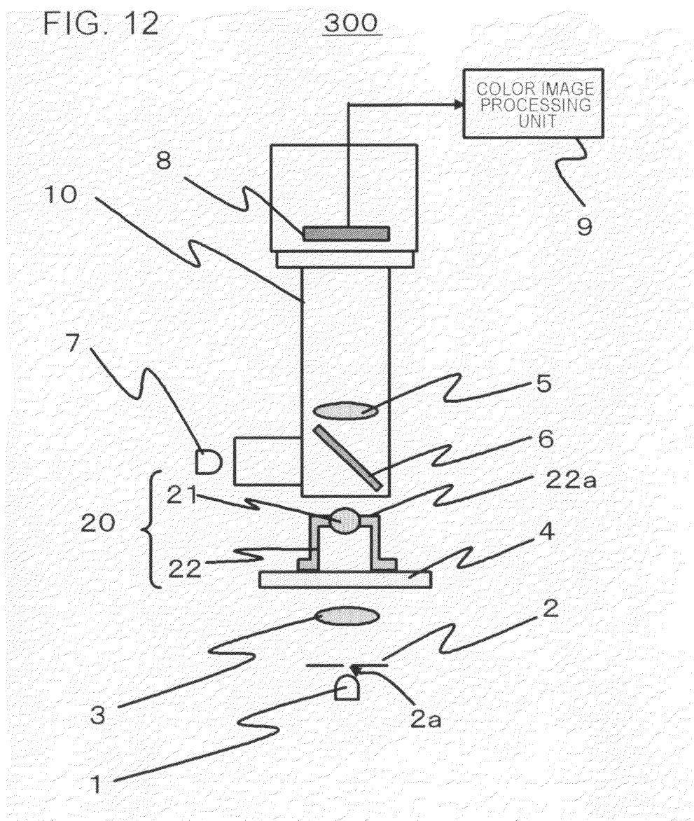

FIG. 12 is a schematic front cross-sectional view of a lens shift measuring apparatus 300 according to a first modification. In the above-described embodiments, the imaging lens unit 10 has the imaging lens 5 and the half mirror 6 that is disposed in the middle of the optical path between the imaging lens 5 and the imaging unit (color CCD camera 8 or CCD camera 90), but the present invention is not limited to this example. For example, as shown in FIG. 12, pseudo coaxial epi-illumination where the half mirror 6 is disposed in the middle of an optical path between the imaging lens 5 and the lens cap 20 may be used.

It is apparent that the present invention is not limited tot the above embodiments, and may be modified and changed without departing from the scope and spirit of the invention.

What is claimed is:

1. A lens shift measuring apparatus, comprising:
an irradiating unit which irradiates light onto a lens-attached member having a lens and a frame body to hold said lens, such that a reflected light from said frame body and a focusing spot formed by focusing light transmitted through said lens by said lens is generated;
an imaging unit which includes said lens-attached member in an imaging range; and
an image processing unit that executes image processing on an imaging result obtained by said imaging unit and calculates a shift of said lens,
wherein said imaging unit images said reflected light from said frame body and said light transmitted through said lens, and
said image processing unit executes, as said image processing,
a first process, in which, a position of a predetermined portion of said frame body is calculated on the basis of an imaging result of said reflected light,
a second process, in which, a position of said focusing spot is calculated on the basis of an imaging result of said light transmitted through said lens, and
a third process, in which, a shift amount of said position of said focusing spot with respect to said predetermined portion is calculated on the basis of processing results of said first and second processes, as said shift of said lens.

2. The lens shift measuring apparatus according to claim 1,
wherein, in said third process, a shift direction of said focusing spot with respect to said predetermined portion is also calculated on the basis of said processing results of said first and second processes.

3. The lens shift measuring apparatus according to claim 1,
wherein said irradiating unit includes
a first irradiating unit which irradiates first light onto said lens-attached member, such that the reflected light from said frame body is generated, and
a second irradiating unit which irradiates second light onto said lens-attached member, such that said focusing spot is generated,
said imaging unit images said first light reflected from said frame body and said second light transmitted through said lens,
in said first process, said position of said predetermined portion of said frame body is calculated on the basis of an imaging result of said first light, and
in said second process, a position of a focusing spot of said second light focused by said lens is calculated on the basis of an imaging result of said second light.

4. The lens shift measuring apparatus according to claim 3,
wherein wavelengths of said first light and said second light are different from each other,
said imaging unit is a color imaging unit which images a color image,
imaging is performed by said imaging unit, in a state in which said first light from said first irradiating unit and said second light from said second irradiating unit are irradiated respectively, and
said image processing unit extracts the imaging result of said first light and the imaging result of said second light from the imaging result obtained by said imaging unit.

5. The lens shift measuring apparatus according to claim 3, further comprising:
a control unit which controls the operation of said first irradiating unit, said second irradiating unit, said imaging unit, and said image processing unit,
wherein said control unit executes first control and second control, and
by the first control, a first imaging operation for imaging said first light reflected from said frame body is executed by said imaging unit, in a state in which said first light is irradiated from said first irradiating unit and irradiation of said second light from said second irradiating unit is stopped, and said first process is executed by said image processing unit, on the basis of an imaging result obtained by executing said first imaging operation, and
by the second control, a second imaging operation for imaging said second light transmitted through said lens is executed by said imaging unit, in a state in which said second light is irradiated from said second irradiating unit and irradiation of said first light from said first irradiating unit is stopped, and said second process is executed by said image processing unit, on the basis of an imaging result obtained by executing said second imaging operation.

6. The lens shift measuring apparatus according to claim 3,
wherein said second irradiating unit includes
a second light source which emits said second light, and
a converting unit which converts said second light emitted from said second light source into parallel light, before said second light reaches said lens.

7. The lens shift measuring apparatus according to claim 3,
wherein said first irradiating unit includes
a first light source which emits said first light, and
a half mirror which reflects said first light emitted from said first light source to the side of said lens-attached member and transmits said first light reflected from said frame body to the side of said imaging unit, and
the lens shift measuring apparatus further comprises an imaging lens which images said first light reflected from said frame body and said second light transmitted through said lens in said imaging unit.

8. The lens shift measuring apparatus according to claim 3, further comprising:
a holding unit which holds said lens-attached member between said second irradiating unit and said imaging unit,
wherein said holding unit is formed of a material transmitting said second light.

9. A lens shift measuring method, comprising:
calculating a position of a predetermined portion of a frame body, on the basis of an imaging result obtained by imaging reflected light from said frame body, in a state in which light is irradiated onto a lens-attached member having a lens and said frame body to hold said lens, such that said reflected light from said frame body is generated;
calculating a position of a focusing spot, on the basis of an imaging result obtained by imaging light transmitted through said lens, in a state in which said light is irradiated onto said lens-attached member, such that said focusing spot formed by focusing said light transmitted through said lens by said lens is generated; and
calculating a shift amount of said position of said focusing spot with respect to said predetermined portion as a shift of said lens.

10. The lens shift measuring method according to claim 9,
wherein, in said calculating said shift amount of said position of said focusing spot, a shift direction of said focusing spot with respect to said predetermined portion is also calculated.

11. The lens shift measuring method according to claim 9, further comprising:
irradiating first light onto said lens-attached member such that said reflected light from said frame body is generated, irradiating second light having a wavelength different from a wavelength of said first light onto said lens-attached member such that a focusing spot formed by focusing said second light transmitted through said lens by said lens is generated, and imaging said first light reflected from said frame body and said second light transmitted through said lens as a color image at one time; and
extracting an imaging result of said first light and an imaging result of said second light from an imaging result obtained by said one-time imaging,
wherein, in said calculating said position of said predetermined portion, said position of said predetermined portion is calculated on the basis of said extracted imaging result of said first light, and
in said calculating said position of said focusing spot, said position of said focusing spot is calculated on the basis of said extracted imaging result of said second light.

12. The lens shift measuring method according to claim 9,
wherein said imaging said reflected light from said frame body and said imaging said light transmitted through said lens are executed at different timings.

13. An optical module manufacturing method, comprising:
calculating a position of a predetermined portion of a frame body, on the basis of an imaging result obtained by imaging reflected light from said frame body, in a state in which light is irradiated onto a lens-attached member having a lens and said frame body to hold said lens, such that said reflected light from said frame body is generated;
calculating a position of a focusing spot, on the basis of an imaging result obtained by imaging light transmitted through said lens, in a state in which said light is irradiated onto said lens-attached member, such that said focusing spot formed by focusing said light transmitted through said lens by said lens is generated;
calculating a shift amount and a shift direction of a position of said focusing spot with respect to said predetermined portion as a shift of said lens; and
bonding a stem of a stem unit, which has said stem, a carrier provided on the stem, and a light emitting element provided on said carrier, to said frame body of said lens-attached member,
wherein, in said bonding said stem of said stem unit to said frame body, a relative positions of said stem unit and said lens-attached member are corrected such that said shift amount calculated by said calculating said shift amount and said shift direction of said position of said focusing spot is corrected, and said stem and said frame body are bonded to each other.
